(19) United States
(12) Patent Application Publication
(10) Pub. No.: US 2025/0233351 A1
(43) Pub. Date: Jul. 17, 2025

(54) CONNECTOR

(71) Applicant: Yazaki Corporation, Tokyo (JP)

(72) Inventors: Hiroki KITAGAWA, Shizuoka (JP); Shotaro SHIBATA, Shizuoka (JP); Motohide SATO, Shizuoka (JP); Kengo AOSHIMA, Shizuoka (JP); Takashi ISHIHARA, Shizuoka (JP); Narumi SUZUKI, Shizuoka (JP)

(73) Assignee: Yazaki Corporation, Tokyo (JP)

(21) Appl. No.: 19/013,551

(22) Filed: Jan. 8, 2025

(30) Foreign Application Priority Data
Jan. 17, 2024 (JP) 2024-005239

(51) Int. Cl. H01R 13/52

(52) U.S. Cl. CPC H01R 13/5219

(57) ABSTRACT

In a connector, routing holes include an inclined surface in which a distance to an extension axis of a central axis of packing holes becomes closer from a first opening end toward a second opening end. A first end of a inclined surface at a position closest to the first opening end faces an interior of a housing body in a direction opposite to a first direction, and a second end of the inclined surface at a position closest to the second opening end forms a narrowest opening part in the routing holes.

### CROSS REFERENCE TO RELATED APPLICATION

The present application is based on, and claims priority from the Japanese Patent Application No. 2024-005239, filed on Jan. 17, 2024, the entire contents of which are incorporated herein by reference.

### TECHNICAL FIELD

The present disclosure relates to a connector.

### BACKGROUND

There is a conventionally known connector in which an end of an electric wire to be joined to a terminal is received inside a housing. JP 2022-168522 A discloses a technology related to a connector having a sealing member in close contact with an outer peripheral surface of an electric wire and an inner peripheral surface of a housing in order to prevent moisture from entering the housing. The connector has a cylindrical shield shell through which the electric wire penetrates while surrounding the outer peripheral surface of the housing. The shield shell has, in addition to a first protrusion which prevents the sealing member from coming off, a second protrusion which can contact the electric wire, and is provided further away from the sealing member than the first protrusion in a longitudinal direction of the electric wire. By providing the second protrusion, the sealing member is prevented from deforming, even if the electric wire bends due to oscillation or the like, thereby suppressing the deterioration of waterproof performance.

### SUMMARY OF THE INVENTION

The connector disclosed in JP 2022-168522 A has a standard shape in which a direction of connection to an external connector, and a direction of leading out an electric wire to the outside, are opposite to each other in a straight line, so that the degree of bending of the electric wire due to swinging is relatively small even if it occurs. On the other hand, in a general U-shaped connector in which a direction of connection to an external connector, and a direction of leading out an electric wire to the outside, are the same, the electric wire may be bent in an L-shape inside the housing. It is difficult to apply the technology disclosed in JP 2022-168522 A to the U-shaped connector, and a particular improvement is required, if the deterioration of waterproof performance should be prevented.

It is an object of the present disclosure to provide a connector which is advantageous in preventing the deterioration of waterproof performance even when the degree of bending of an electric wire inside is large.

An aspect of the present disclosure is a connector connected to an external connector, including a plurality of terminals; a housing body that receives ends of a plurality of electric wires joined to each of the terminals; an electric wire lead-out portion in a cylindrical form that is continuous with the housing body and leads out the plurality of electric wires to the outside in a first direction of connection to the external connector; and a wire packing that is attached to an inner wall surface of the electric wire lead-out portion in a closely contacted manner, and has a plurality of packing holes that allows the electric wires pass through while closely contacting with each of the electric wires; in that the electric wire lead-out portion has a plurality of routing holes that allow each of the electric wires to be routed between a first opening end that faces the inside of the housing body and a second opening end that faces a part of the wire packing attached to the inner wall surface in a first direction; each of the routing holes includes an inclined surface in which a distance to an extension axis of a central axis of the packing holes becomes closer from a first opening end toward a second opening end; a first end of the inclined surface at a position closest to the first opening end faces an interior of the housing body in a direction opposite to the first direction; and a second end of the inclined surface at a position closest to the second opening end forms a narrowest opening part in the routing holes.

According to the configuration described above, it is possible to provide a connector advantageous in preventing deterioration in waterproof performance even when the degree of bending of an electric wire inside the connector is large.

### BRIEF DESCRIPTION OF THE DRAWINGS

FIG. 1 is a perspective view of a connector according to a first embodiment.

FIG. 2 is an exploded perspective view of the connector according to the first embodiment.

FIG. 3 is a cross-sectional view of the connector cut at a section III-III in FIG. 1.

FIG. 4 is a perspective view of an outer housing according to the first embodiment.

FIG. 5 is a perspective view of a connector according to a second embodiment cut in the same position as FIG. 3.

FIG. 6 is a perspective view of a cross section of an outer housing extracted from FIG. 5.

### DETAILED DESCRIPTION OF THE INVENTION

Hereinafter, a connector according to each embodiment will be described in detail with reference to the drawings. Note that the dimensional ratios in the drawings are exaggerated for convenience of explanation and may differ from the actual ratios.

### First Embodiment

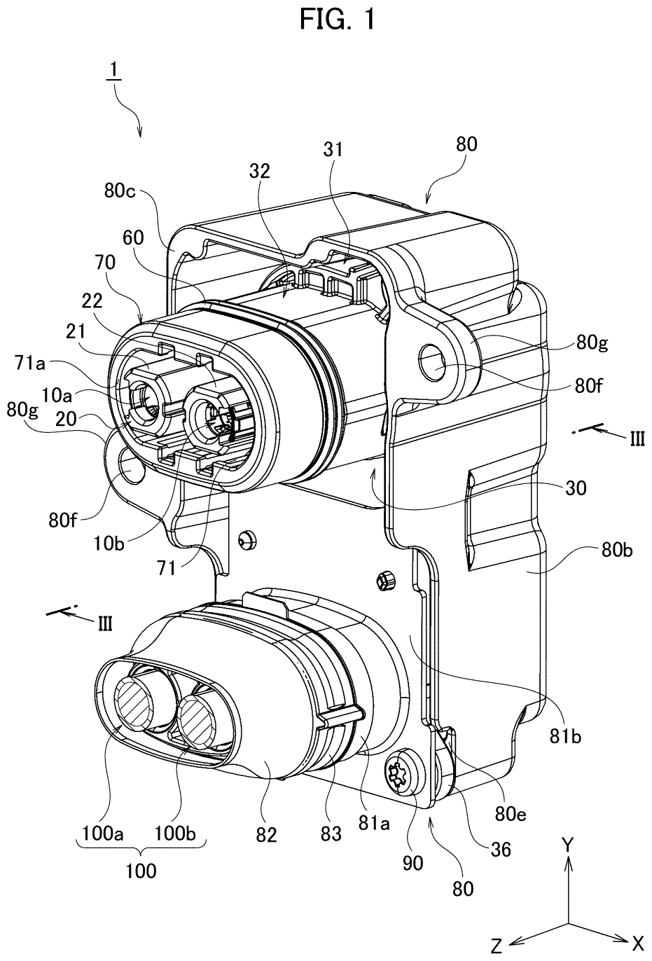

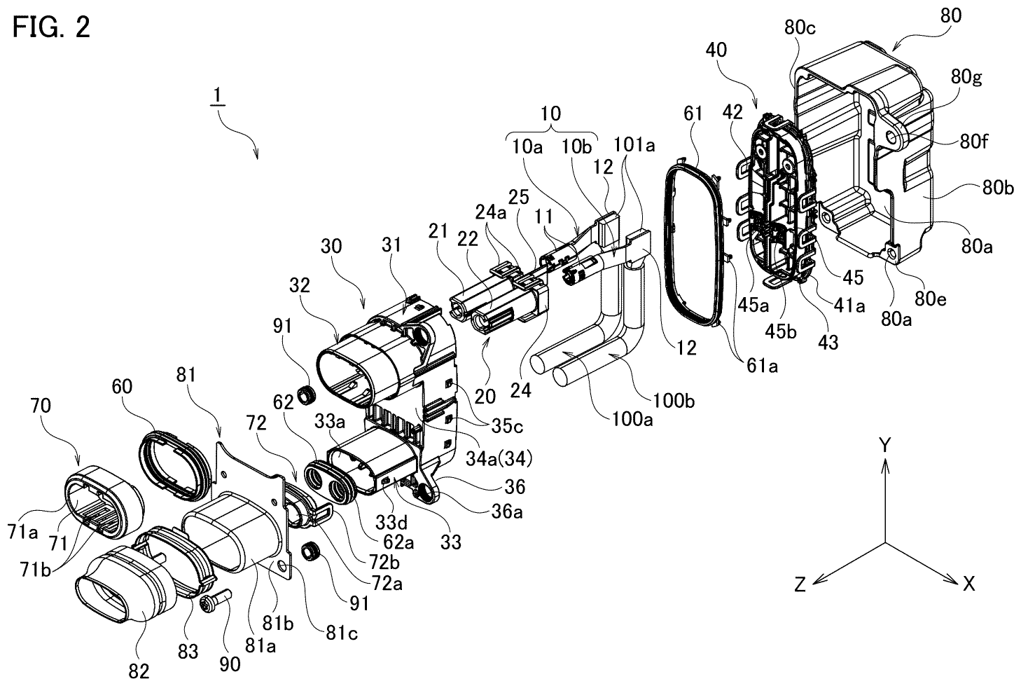

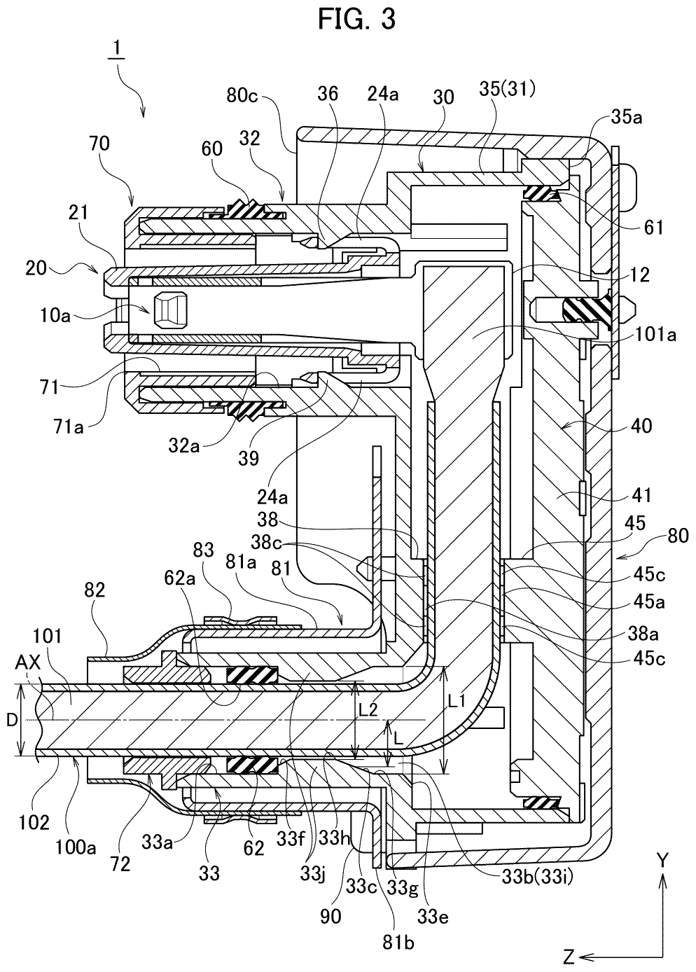

FIG. 1 is a perspective view of a connector 1 according to a first embodiment. FIG. 2 is an exploded perspective view of the connector 1. FIG. 3 is a cross-sectional view of the connector 1 cut at section III-III in FIG. 1. The cross section in FIG. 3 is an imaginary plane that passes through a center axis of a first terminal receptacle 21 and the first electric wire 100a of an inner housing 20 described later. The imaginary plane is the YZ plane in this embodiment.

The connector 1 is, for example, a high-voltage connector that can be employed in a drive-system electrical component such as an inverter, a DC/DC converter, or a charger mounted on an electric vehicle or a hybrid vehicle. In this embodiment, the connector 1 is a two pole high-voltage connector mounted on a vehicle that is connected to ends of the two electric wires 100, a first electric wire 100a and a second electric wire 100b. The electric wires 100 have a core wire 101 as a conductor, and a coating portion 102 as an insulator for coating the core wire 101. The electric wires 100 are connected to an electrical component on one end, and the electric wires 100 are connected to the connector 1 on the other end. The coating portion 102 of the electric wires 100 is removed at one end which is connected to the connector 1, so that an end 101a of the core wire 101 is exposed. The core wire 101 may actually be composed of a plurality of wires, but in the following drawings, it is simply illustrated as a single conductor member.

The connector 1 includes a plurality of terminals 10, an inner housing 20, an outer housing 30, and a rear cover 40 as a group of components related to electrical connection.

In this embodiment, there are two terminals 10: a first terminal 10a attached to an end of the first electric wire 100a, and a second terminal 10b attached to an end of the second electric wire 100b. The first terminal 10a and the second terminal 10b are female terminals made of metal and having the same shape, and each have a connecting portion 11 and a joint 12.

The connecting portion 11 is a cylindrical portion into which a rod-shaped male terminal can be freely inserted as an external terminal of an external connector to be connected to the connector 1. The connecting portion 11 has a leaf spring that presses a part of the male terminal against an inner wall of the connecting portion 11 in order to stably maintain a conductive state with the male terminal inserted therein. The leaf spring may be a portion integrated with the connecting portion 11, or a leaf spring member prepared separately and arranged in advance inside the connecting portion 11.

The joint 12 is formed as a flat plate for joining the end 101a of the core wire 101. If one axial end of the connecting portion 11 is an opening end into which the male terminal is inserted, the joint 12 is integrated with the other axial end of the connecting portion 11. Hereinafter, in this embodiment, it is assumed that an axial direction of the connecting portion 11 is in a Z direction when the terminals 10 are arranged in the connector 1. In this case, the joint 12 may be a flat plate parallel to both the Z direction and a Y direction. For example, a planar shape of the joint 12 may be substantially rectangular, with two edges aligned in the Z direction and two other edges aligned in the Y direction, perpendicular to the Z direction. One surface of the joint 12 is a joining surface to which the end 101a is joined.

In the present embodiment, the end 101a of the core wire 101 is joined to the joint 12 by ultrasonic joining. In ultrasonic joining, the joint 12 is clamped together with the end 101a by a horn and an anvil (not illustrated), and the end 101a is joined to the joint 12 by applying ultrasonic vibration from the horn. Therefore, as illustrated in FIG. 2, the end 101a joined to the joint 12 is formed as a flat plate having a substantially rectangular planar shape.

During ultrasonic joining, a direction from the joint 12 to the connecting portion 11 in the axial direction of the connecting portion 11, and a direction from the end 101a on the joint 12 to the main body of each of the electric wires 100, are displaced by 90° for the terminals 10. That is, when the terminals 10 are arranged in the connector 1, the end 101a is oriented in the Y direction with respect to one surface of the joint 12 when the axial direction of the connecting portion 11 is aligned in the Z direction. Then, each of the electric wires 100 extends from the end 101a in a direction opposite to the Y direction with the end 101a on the joint 12 as a starting point.

The inner housing 20 is an insulating member made of a synthetic resin, for example, for holding both of the terminals 10 therein for protecting the terminals 10. The inner housing 20 includes the first terminal receptacle 21, a second terminal receptacle 22, a base 24, and a reinforcing structure 25.

The first terminal receptacle 21 is a cylindrical portion that receives the connecting portion 11 of the first terminal 10a. The second terminal receptacle 22 is a cylindrical portion that receives the connecting portion 11 of the second terminal 10b. The first terminal receptacle 21 and the second terminal receptacle 22 receive the connecting portion 11 so that an opening direction of the connecting portion 11 received therein, that is, a direction opposite to a direction in which the male terminal is inserted, is a direction aligned in the first direction. In this embodiment, the first direction is the Z direction. A tip of the first terminal receptacle 21 and a tip of the second terminal receptacle 22 are open in the first direction, and do not prevent a male terminal from entering the connecting portion 11. The first terminal receptacle 21 and the second terminal receptacle 22 are arranged in the same stage in the Y direction as a second direction defined below, and are spaced from each other in the X direction as a third direction defined below.

The base 24 supports the first terminal receptacle 21 and the second terminal receptacle 22. The base 24 supports root ends of the first terminal receptacle 21 and the second terminal receptacle 22 on a front side in the first direction. An internal space of the first terminal receptacle 21 and an internal space of the second terminal receptacle 22 are open in a direction opposite to the first direction on a rear surface side in the first direction.

The base 24 includes a total of four locks 24a. For example, two locks 24a are arranged opposite two other locks 24a in the second direction. On the other hand, a total of four first engaging claws 37 are arranged inside the housing body 31 of the outer housing 30. Two first engaging claws 37 are arranged opposite two other first engaging claws 37 in the second direction. When the inner housing 20 is attached to the outer housing 30, the locks 24a are engaged with the first engaging claws 37, thereby preventing the inner housing 20 from coming off the outer housing 30.

The reinforcing structure 25 is a structure in which a plurality of reinforcing ribs are combined to ensure the strength of the inner housing 20. The reinforcing structure 25 is provided on a rear surface of the base 24 so as not to interfere with the arrangement of the terminals 10 and the electric wires 100.

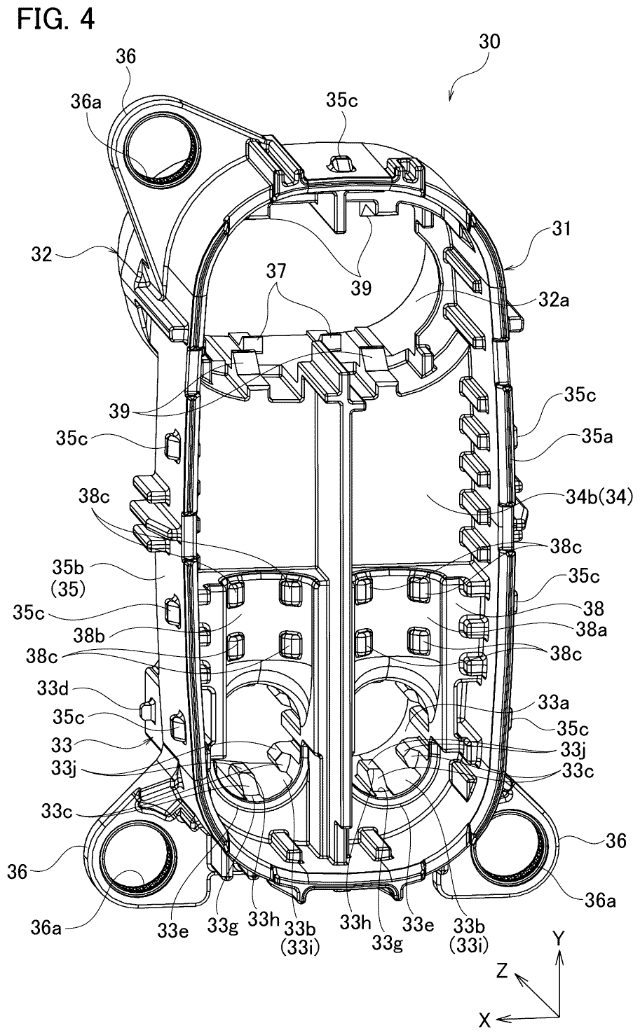

FIG. 4 is a perspective view of the outer housing 30 in a direction in which an internal space can be visually recognized from an opening formed by an opening end 35a.

The outer housing 30 is made of a synthetic resin, for example, and is an insulating member that entirely protects both of the terminals 10 by receiving at least a part of the inner housing 20 and the joint 12 of each of the terminals 10. The outer housing 30 has the housing body 31, a connector shell 32, and an electric wire lead-out portion 33.

The housing body 31 is a box in which, when a first direction is a length direction, a second direction perpendicular to the first direction is a height direction, and a third direction perpendicular to both the first direction and the second direction is a width direction. In this embodiment, the first direction is the Z direction, the second direction is the Y direction, and the third direction is the X direction as described above. The housing body 31 has a front wall 34, an annular side wall 35, and a plurality of support pieces 36.

The front wall 34 is a wall perpendicular to the first direction, and is supported by a first wall surface 34a (see FIG. 2) so that the connector shell 32 and the electric wire lead-out portion 33 are separated from each other in the second direction. The planar shape of the front wall 34 is substantially a rectangle defined by a long side substantially aligned in the second direction and a short side substantially aligned in the third direction.

The front wall 34 has a first electric wire contact 38 on a second wall surface 34b facing the interior of the housing body 31. When the rear cover 40 is attached to the outer housing 30, the first electric wire contact 38 faces, and is arranged spaced apart from, a second electric wire contact 45 provided on the rear cover 40. The first electric wire contact 38 has a first curved surface groove 38a and a second curved surface groove 38b, each extending in a second direction and including a curved surface matching a shape of a side surface of the electric wires 100 routed inside the housing body 31. The first curved surface groove 38a receives a part of the side surface of the first electric wire 100a. The second curved surface groove 38b receives a part of the side surface of the second electric wire 100b. Each of the first curved surface groove 38a and the second curved surface groove 38b may have a plurality of first ribs 38c. In this embodiment, both the first curved surface groove 38a and the second curved surface groove 38b have a total of four first ribs 38c arranged in two rows in the second direction.

The annular side wall 35, together with the front wall 34, forms an internal space for receiving at least the joint 12 of the terminals 10. One annular end of the annular side wall 35 in the first direction is continuous with a peripheral edge of the front wall 34. The other annular end of the annular side wall 35 in the first direction is an opening end 35a that forms an opening opposed to the front wall 34. When the connector 1 is assembled, the two terminals 10, each attached to ends of the electric wires 100, are received in the housing body 31 from the opening formed by the opening end 35a. Further, the annular side wall 35 has a plurality of engaging portions 35c provided on an outer wall surface 35b and spaced apart from each other in the circumferential direction.

The support pieces 36 are provided on the outer wall surface 35b of the annular side wall 35, and includes fitting holes 36a into which annular collars 91 are fitted. The fitting holes 36a penetrate the support pieces 36 in the first direction.

The connector shell 32 has a shell opening 32a having a shape of an elongated round hole in cross section and opening in the first direction. The connector shell 32 is a cylindrical portion which is fitted with a part of the external connector when the external connector having a male terminal is connected to the connector 1. The connector shell 32 is provided so as to protrude in the first direction from the front wall 34 of the housing body 31. The shell opening 32a penetrates the inside of the housing body 31 from the outside of the outer housing 30, and can receive the inner housing 20. In the cross section of the elongated round hole of the shell opening 32a, the second direction is a longitudinal direction in accordance with the arrangement relationship between the first terminal receptacle 21 and the second terminal receptacle 22 in the inner housing 20.

An outer periphery of the connector shell 32 includes a lower surface which is located on a tip side in the first direction and to which a unit packing 60 is attached, and an upper surface located on a base side in the first direction. A shape of an outer periphery of the upper surface is larger than a shape of an outer periphery of the lower surface. Therefore, at least a part of the unit packing 60 faces an end of the upper surface in the first direction when the unit packing 60 is attached to the lower surface. Therefore, movement of the unit packing 60 to the base side of the connector shell 32 by a certain amount or more is restricted.

Further, the connector shell 32 has a plurality of first engaging claws 37 across the shell opening 32a. In this embodiment, there are four first engaging claws 37 as described above. Similarly, the connector shell 32 has a plurality of second engaging claws 39 across the shell opening 32a. In this embodiment, there are four second engaging claws 39. The four second engaging claws 39 are arranged in pairs so as to face each other in the second direction.

The electric wire lead-out portion 33 is a cylindrical portion for leading the electric wires 100 out from the inside of the housing body 31 to the outside of the outer housing 30, through a through-space formed by an inner wall surface 33a, and having an elongated round hole shape in cross section opening in the first direction. The electric wire lead-out portion 33 is provided to protrude in the first direction from the front wall 34 of the housing body 31. In an elongated round cross section of the through-space, the second direction is the longitudinal direction, so that the electric wires 100 are aligned in the second direction in accordance with the arrangement relationship of the first terminal receptacle 21 and the second terminal receptacle 22 in the inner housing 20. The electric wire lead-out portion 33 has a plurality of routing holes 33b, and a plurality of holder engaging portions 33d.

The routing holes 33b extend in the first direction, and enable each of the electric wires 100 to lead out from the inside of the housing body 31 to be routed in the first direction. Specifically, the wiring holes 33b route the electric wires 100 between the first opening end 33e and the second opening end 33f located opposite to each other. The first opening end 33e is an opening end facing the interior of the housing body 31. The second opening end 33f is an opening end facing a portion of the wire packing 62 attached to the inner wall surface 33a in the first direction. In the present embodiment, two routing holes 33b are provided in parallel in the third direction, since two electric wires 100 are led out from the inside of the housing body 31.

The cross section of a through hole in the first opening end 33e is generally elliptical with the major axis in the second direction corresponding to the Y direction and the minor axis in the third direction corresponding to the X direction, and is generally constant in the first direction. A part of an inner peripheral surface 33i is continuous with the inner wall surface 33a to which the wire packing 62 is attached.

Here, with respect to the cross-sectional shape of the through hole in the first opening end 33e, the direction in which the major axis of the ellipse is defined is aligned in an extending direction of the electric wires 100 extending from the joint 12 of each of the terminals 10 inside the housing body portion 31. Therefore, for example, when assembling the connector 1, it is an advantage that an operator can easily insert the electric wires 100 extending from the joint 12 inside the housing body 31 into the routing holes 33b while bending it.

Further, each of the routing holes 33b has a plurality of ribs 33j arranged so as to be spaced from each other along an inner periphery of the inner peripheral surface 33i. Here, an extension axis AX of a center axis of the packing holes 62a when the wire packing 62 is attached to the inner wall surface 33a is referred to define the shape or the like of ribs 33j. The ribs 33j are elongated in the first direction as the longitudinal direction, and protrudes toward the extension axis AX. In this embodiment, as an example, each of the routing holes 33b has eight ribs 33j. Further, the ribs 33j included in each of the routing holes 33b may be arranged at approximately equal intervals in the circumferential direction.

The ribs 33j have an inclined surface 33c having one end as a first end 33g and the other end as a second end 33h. The first end 33g is an end closest to the first opening end 33e. The second end 33h is an end closest to the second opening end 33f. The inclined surface 33c is inclined so that a distance L to the extension axis AX gradually narrows from the first opening end 33e toward the second opening end 33f.

Here, the first end 33g faces the interior of the housing body 31 in a direction opposite to the first direction. Therefore, no portion of the routing holes 33b is narrower than an opening part at the first end 33g in a direction from the first end 33g toward the interior of the housing body 31. For example, in the second direction corresponding to the Y direction, an opening distance at the first end 33g is indicated by a first distance L1, as illustrated in FIG. 3.

On the other hand, the second end 33h forms a narrowest opening part at the routing holes 33b. For example, in the second direction corresponding to the Y direction, the opening distance at the second end portion 33h is indicated by a second distance L2, as illustrated in FIG. 3. The second distance L2 is smaller than the first distance L1 related to the first end 33g. Assuming that the second ends 33h of the ribs 33j are connected in a circumferential direction of the routing holes 33b, a virtual circle is defined in which an inner diameter can be a dimensional value of the second distance L2. In this case, an inner diameter of a virtual circle, that is, the dimensional value of the second distance L2, may be set equal to the outer diameter D of the electric wires 100.

In the present embodiment, the holder engaging portions 33d are provided at both ends of the electric wire lead-out portion 33 in the third direction corresponding to the X direction. The holder engaging portions 33d engage with engaging portions 72b provided in a rear holder 72.

In other words, in the structure of the outer housing 30, in the connector 1, a direction in which the shell opening 32a of the connector shell 32 is oriented, that is, the direction in which the connector is connected to the external connector, and the direction in which the electric wires 100 are led out from the electric wire lead-out portion 33, are both aligned in the same direction. In this embodiment, the direction in which the shell opening 32a of the connector shell 32 is directed, and the direction in which the electric wires 100 are led out from the electric wire lead-out portion 33, are both aligned in the first direction corresponding to the Z direction.

The rear cover 40 is made of, for example, a synthetic resin, and is an insulating member for covering an opening formed by the opening end 35a after the terminals 10 with the end 101a joined to the joint 12 are received together with ends of the electric wires 100 in the housing body 31 of the outer housing 30. The rear cover 40 has a body wall (not illustrated), a plurality of locking portions 42, a plurality of packing-locking portions 43, and a second electric wire contact 45.

The body wall is a flat plate having an outer peripheral edge 41a along the opening end 35a of the housing body 31 when the rear cover 40 is attached to the outer housing 30. An inner wall surface of the body wall faces the front wall 34 of the housing body 31 when the rear cover 40 is attached to the outer housing 30.

The locking portions 42 are provided on the outer peripheral edge 41a of the body wall at intervals from each other in a circumferential direction along the outer peripheral edge 41a. When the rear cover 40 is attached to the outer housing 30, the locking portions 42 prevent the rear cover 40 from coming off the outer housing 30 by engaging the engaging portions 35c on the annular side wall 35.

The packing-locking portions 43 are provided on the outer peripheral edge 41a of the body wall, spaced at intervals from each other in the circumferential direction along the outer peripheral edge 41a, avoiding the plurality of locking portions 42. A rear cover packing 61 described later is provided with a plurality of engaging projections 61a. Each of the packing-locking portions 43 engages one of the engaging projections 61a on the rear cover packing 61 when the rear cover 40 is attached to the outer housing 30.

The second electric wire contact 45 is provided on the inner wall surface of the body wall. The second electric wire contact 45 contacts the electric wires 100 when the rear cover 40 is attached to the outer housing 30. The second electric wire contact 45 has a first curved surface groove 45a and a second curved surface groove 45b, each extending in the second direction and including a curved surface matching a shape of the side surface of the electric wires 100 routed inside the housing body 31. The first curved surface groove 45a receives a part of the side surface of the first electric wire 100a. The second curved surface groove 45b receives a part of the side surface of the second electric wire 100b. Each of the first curved surface groove 45a and the second curved surface groove 45b may have four second ribs similar to the first ribs 38c provided on the outer housing 30.

When the rear cover 40 is attached to the outer housing 30, the first electric wire contact 38 and the second electric wire contact 45 clamp the electric wires 100. Specifically, a part of the first electric wire 100a is held between the first curved surface groove 38a provided as a part of the outer housing 30, and the first curved surface groove 45a provided as a part of the rear cover 40. Then, the four first ribs 38c of the first curved surface groove 38a and the four second ribs of the first curved surface groove 45a are press-fitted into the coating portion 102 on the outer periphery of the first electric wire 100a. Similarly, a part of the second electric wire 100b is clamped between the second curved surface groove 38b as a part of the outer housing 30 and the second curved surface groove 45b as a part of the rear cover 40. Then, the four first ribs 38c of the second curved surface groove 38b, and the four second ribs of the second curved surface groove 45b, are press-fitted into the coating portion 102 on the outer periphery of the second electric wire 100b. Therefore, for example, a reaction force generated by oscillation of the electric wires 100 due to vibration of a vehicle is prevented from being transmitted to the terminals 10 through the electric wires 100 led out from the electric wire lead-out portion 33. Therefore, a portion in which the joint 12 as a part of the terminals 10 is joined to the end 101a of the core wire 101 of the electric wires 100 is protected, so that the reliability of a joint can be improved.

Further, the connector 1 includes the unit packing 60, the rear cover packing 61, and a wire packing 62 as waterproof members for preventing moisture from entering the outer housing 30 from the outside.

The unit packing 60 is an annular elastic member closely attached to the outer peripheral surface of the connector shell 32 in the outer housing 30. The unit packing 60 seals a space between the outer peripheral surface of the connector shell 32 and the fitting surface of an external connector when the external connector is connected to the connector 1.

The rear cover packing 61 is an annular elastic member closely attached to the opening end 35a of the housing body 31 of the outer housing 30. When the rear cover 40 is attached to the outer housing 30, the rear cover packing 61 seals a space between the opening end 35a of the housing body 31 and the outer peripheral edge 41a of the rear cover 40.

The wire packing 62 is an elastic member in the shape of an elongated round flat plate that is closely attached to the inner wall surface 33a of the electric wire lead-out portion 33 of the outer housing 30. In addition, the wire packing 62 has a plurality of packing holes 62a that allows the electric wires 100 pass through while closely contacting with each of the electric wires 100. In this embodiment, there are two packing holes 62a, since the wire packing 62 allows both of the electric wires 100 to individually pass through. When the wire packing 62 is attached to the inner wall surface 33a of the wire lead-out portion 33, the packing holes 62a are close to the second opening end 33f of one of the routing holes 33b. When the wire packing 62 is attached to the inner wall surface 33a, the center axis of each of the packing holes 62a is aligned in the first direction. Here, an extension axis of a center axis of the packing holes 62a is denoted as the “extension axis AX”. The wire packing 62 seals a space between the inner wall surface 33a of the electric wire lead-out portion 33 and the electric wires 100 that pass through a through-space of the electric wire lead-out portion 33.

Further, the connector 1 includes a front holder 70 and the rear holder 72 as holding members for different kinds of packing.

The front holder 70 is made of a synthetic resin, and is a cylindrical member attached to the connector shell 32 in order to prevent the unit packing 60 from coming off the connector shell 32 of the outer housing 30. The front holder 70 is formed to engage with a tip of the connector shell 32 while being partially received in the shell opening 32a of the connector shell 32. When the front holder 70 is attached to the connector shell 32, it faces at least a part of the unit packing 60 in the first direction. Therefore, even if the unit packing 60 moves to the tip of the connector shell 32, further movement is restricted by abutment on a part of the front holder 70, thus preventing it from coming off the connector shell 32.

The first terminal receptacle 21 and the second terminal receptacle 22 of the inner housing 20 penetrate inside the inner wall 71 of the front holder 70. An opening 71a communicating with the inner wall 71 exposes tips of the first terminal receptacle 21 and the second terminal receptacle 22 to the outside.

Further, the front holder 70 has a plurality of engaging portions 71b on a part of the inner wall 71. The engaging portions 71b are engaged with the first engaging claws 37 provided on the connector shell 32. That is, in the present embodiment, four engaging portions 71b are provided corresponding to the number of the first engaging claws 37 provided. When the front holder 70 is attached to the connector shell 32, the engaging portions 71b are engaged with the first engaging claws 37 to prevent the front holder 70 from coming off the connector shell 32.

The rear holder 72 is made of a synthetic resin, and is attached to the electric wire lead-out portion 33 to prevent the wire packing 62 from coming off the electric wire lead-out portion 33 of the outer housing 30. The rear holder 72 has two through-holes 72a for each enabling the electric wires 100 to penetrate, and is an elongated flat plate member similar in shape to the wire packing 62. The rear holder 72 is inserted into the through-space from a tip of the electric wire lead-out portion 33, and supported by the electric wire lead-out portion 33 with the wire packing 62 that seals the space between the inner wall surface 33a of the electric wire lead-out portion 33, and the electric wires 100. Thus, the rear holder 72 prevents the wire packing 62 from coming off the electric wire lead-out portion 33.

Further, the rear holder 72 has a plurality of locking portions 72b protruding from an outer peripheral edge in a direction opposite to the first direction. The locking portions 72b are engaged with the holder engaging portions 33d provided in the electric wire lead-out portion 33. That is, in this embodiment, two locking portions 72b are provided corresponding to the number of holder engaging portions 33d provided. When the rear holder 72 is attached to the electric wire lead-out portion 33, the locking portions 72b are engaged with the holder engaging portions 33d, thereby preventing the rear holder 72 from coming off the electric wire lead-out portion 33.

Further, the connector 1 includes an upper shell 80, a lower shell 81, a shield braid 82, and a shield ring 83 as shielding members for shielding noise.

The upper shell 80 is made of metal and covers the housing body 31 of the outer housing 30 with the rear cover 40 attached thereto. The upper shell 80 may cover at least a part of the connector shell 32 or the electric wire lead-out portion 33 of the outer housing 30 while receiving the housing body 31. The upper shell 80 is a box portion defined as having a first direction corresponding to the Z direction as a length direction, a second direction corresponding to the Y direction as a height direction, and a third direction corresponding to the X direction as a width direction. The upper shell 80 has a bottom wall 80a, an annular side wall 80b, a plurality of support portions 80e, and a plurality of support pieces 80g.

The bottom wall 80a is a wall portion orthogonal to the first direction. The planar shape of the bottom wall 80a is a substantially rectangular defined by a long side substantially aligned in the second direction, and a short side substantially aligned in the third direction.

The annular side wall 80b, together with the bottom wall 80a, forms an internal space for receiving the housing body 31. One annular end of the annular side wall 80b in the first direction is continuous with a peripheral part of the bottom wall 80a. The other annular end of the annular side wall 80b in the first direction is an opening end 80c forming an opening facing the bottom wall 80a. When the connector 1 is assembled, the housing body 31 to which the rear cover 40 is attached is accommodated from the opening formed by the opening end 80c.

The support portions 80e have first through-holes 80d, through which bolts 90 after passing through the fitting holes 36a provided in the outer housing 30 pass when the connector 1 is assembled.

The support pieces 80g are portions, for example, provided by bending a part protruding from the opening end 80c of the annular side wall 80b, and each have a second through hole 80f through which a mounting bolt (not illustrated) passes when the connector 1 is attached to a housing of an external connector.

The lower shell 81 is made of metal, and covers a part of the front wall 34 of the housing body 31 of the outer housing 30, and the electric wire lead-out portion 33. The lower shell 81 has a cylindrical portion 81a and a flange 81b.

The cylindrical portion 81a covers the electric wire lead-out portion 33 by receiving the electric wire lead-out portion 33 through a through-space having an elongated round hole in cross section and opening in the first direction. One opening end of the cylindrical portion 81a is a fixing end continuous with the flange 81b. The other opening end of the cylindrical portion 81a is an opening end forming an opening for leading out the electric wires 100 from the electric wire lead-out portion 33.

The flange 81b, which is a flat plate orthogonal to the first direction, faces a part of the front wall 34 to cover a part of the front wall 34. Further, the flange 81b has through-holes 81c through which the bolts 90 pass before passing through the fitting holes 36a provided in the outer housing 30 when the connector 1 is assembled.

The shield braid 82 is a metallic braid, a part of which covers a tip of the cylindrical portion 81a, and another part of which wraps to integrally cover both of the electric wires 100 led out from the cylindrical portion 81a.

The shield ring 83 is a metallic fastening member for press fitting of the shield braid 82 to an outer peripheral surface of the cylindrical portion 81a of the lower shell 81.

Further, the connector 1 includes a plurality of the bolts 90 and a plurality of the annular collars 91 previously fitted into the fitting holes 36a of the outer housing 30 as members for assembling components. As described above, the flange 81b of the lower shell 81 is provided with through-holes 81c. The annular collars 91 are fitted into the fitting holes 36a of the outer housing 30. The support portions 80e of the upper shell 80 are provided with the first through-holes 80d. The bolts 90 are fastened through the through-holes 81c, the annular collars 91 of the fitting holes 36a, and the first through-holes 80d, and whereby the lower shell 81, the outer housing 30, and the upper shell 80 are integrally assembled.

Next, the operation and effect of the connector 1 will be described.

A connector 1 connected to an external connector includes a plurality of terminals and a housing body 31 that receives ends of a plurality of electric wires 100 joined to each terminal 10. The connector 1 includes an electric wire lead-out portion 33 in a cylindrical form that is continuous with the housing body 31 and leads out the plurality of electric wires 100 to the outside in a first direction of connection to the external connector. The connector 1 further includes a wire packing 62 that is attached to an inner wall surface 33a of the electric wire lead-out portion 33 in a closely contacted manner, and has a plurality of packing holes 62a that allows the electric wires pass through while closely contacting with each of the electric wires 100. The electric wire lead-out portion 33 has a plurality of routing holes 33b that allow each of the electric wires 100 to be routed between a first opening end 33e that faces the inside of the housing body 31 and a second opening end 33f that faces a part of the wire packing 62 attached to the inner wall surface 33a in a first direction. The routing holes include an inclined surface 33c in which a distance L to an extension axis of a central axis of the packing holes 62a become closer from the first opening end 33e toward the second opening end 33f. The first end 33g of the inclined surface 33c at a position closest to the first opening end 33e faces an interior of the housing body 31 in a direction opposite to the first direction, and the second end 33h of the inclined surface 33c at a position closest to the second opening end 33f forms a narrowest opening part in the routing holes 33b.

In the illustrated example, the electric wires 100 correspond to the first electric wire 100a and the second electric wire 100b. In the illustrated example, the terminals 10 correspond to the first terminal 10a attached to an end of the first electric wire 100a, and the second terminal 10b attached to an end of the second electric wire 100b. In the illustrated example, the first direction corresponds to the Z direction.

The connector 1 has a general shape of a so-called U-shape in which a direction of connection to the external connector and a direction of leading out the electric wires 100 to the outside are aligned in the first direction. In this case, the electric wires 100, which extend in the second direction intersecting with the first direction, are bent at approximately 90 degrees inside the connector 1, since they are eventually lead out from the electric wire lead-out portion 33 in the first direction. The first direction and the second direction are orthogonal in the above description, but not limited to an orthogonal case.

First, the wire lead-out portion 33 is a portion for leading out the electric wires 100 to the outside, and each of the routing holes 33b routes one of the electric wires 100 inside the wire lead-out portion 33. That is, the narrowest opening portion in each of the routing holes 33b formed at the second end portion 33h of the inclined surface 33c has a shape that allows at least the electric wires 100 to pass through. In each of the routing holes 33b, the inclined surface 33c is inclined so as to gradually approach the packing holes 62a in the first direction. Therefore, the electric wires 100 pulled in the wire lead-out portion 33 from the inside of the housing body 31 contact a part of the inclined surface 33c in each of the routing holes 33b, and are guided toward the packing holes 62a by the inclined surface 33c. Thus, at least inside the wire packing 62 in the wire lead-out portion 33, the electric wires 100 are maintained in an orientation in which a central axis of the electric wires 100 is approximately coaxial with the central axis of the packing holes 62a.

The large bending of the electric wires 100 in the housing body 31 causes an elastic force to return the electric wire 100 to their original shape in the wire lead-out portion 33. On the other hand, with the connector 1, a bias of the electric wires 100 caused by an elastic force is suppressed in the wire packing 62, so that deformation of the wire packing 62, that is, a bias of a general clamping margin is suppressed, and as a result, the deterioration of the waterproof performance can be prevented.

As described above, according to the present embodiment, it is possible to provide the connector 1 advantageous in preventing the deterioration of the waterproof performance even when the degree of bending of the electric wires 100 inside is large.

Further, according to the present embodiment, with respect to the inclined surface 33c, an opening part at the first end 33g facing the inside of the housing body 31 is wider than an opening part at the second end 33h. Therefore, for example, when an operator assembles the connector 1, the electric wires 100 greatly bent inside the housing body 31 are pulled in the wire lead-out portion 33. As a result, interference with the wire lead-out portion 33 rarely occurs, the connector 1 is advantageous in terms of improving ease of assembly.

In the connector 1, each of the routing holes 33b may have an inner peripheral surface 33i partially continuous with the inner wall surface 33a to which the wire packing 62 is attached, and a plurality of ribs 33j arranged along an inner periphery of the inner peripheral surface 33i so as to be spaced from each other. The inclined surface 33c may be provided for each of the ribs 33j.

According to this connector 1, it is effective as an example of providing the inclined surfaces 33c in each wiring hole portion 33b, and it is advantageous to reduce the weight of the outer housing 30 by providing the ribs 33j only as much as is necessary to guide the electric wires 100 toward the packing hole 62a.

### Second Embodiment

In the connector 1 according to the first embodiment, the inclined surface 33c is provided as a part of the ribs 33j in each of the routing holes 33b in the wire lead-out portion 33. On the other hand, in the connector 2 according to a second embodiment, the wire lead-out portion 33 has a plurality of routing holes 33k in which a part of an inner peripheral surface 33n is an inclined surface 33m, instead of the plurality of routing holes 33b.

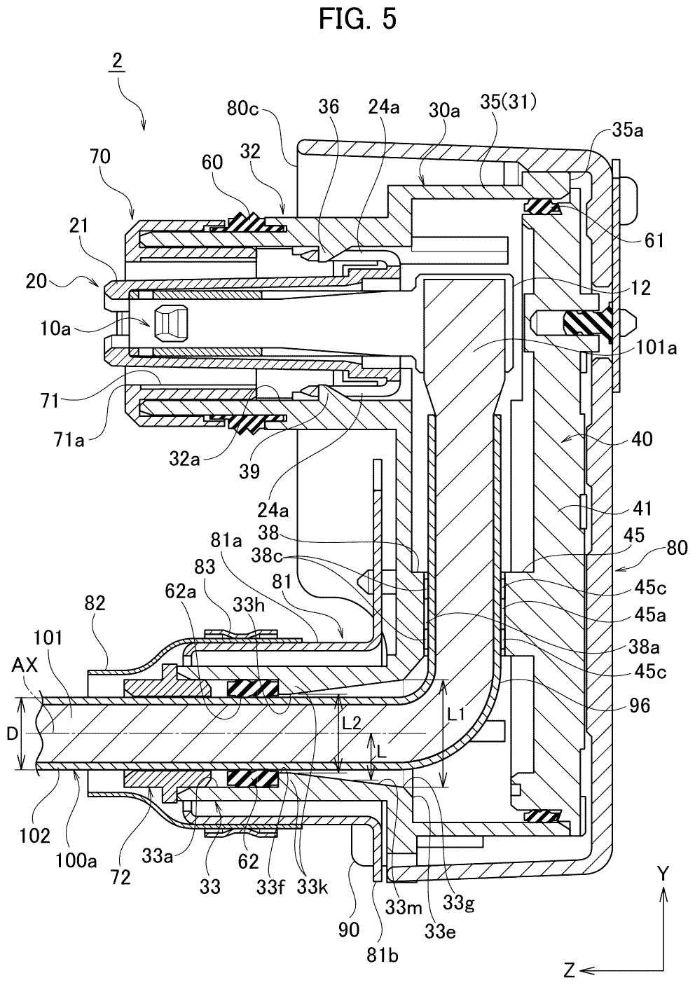

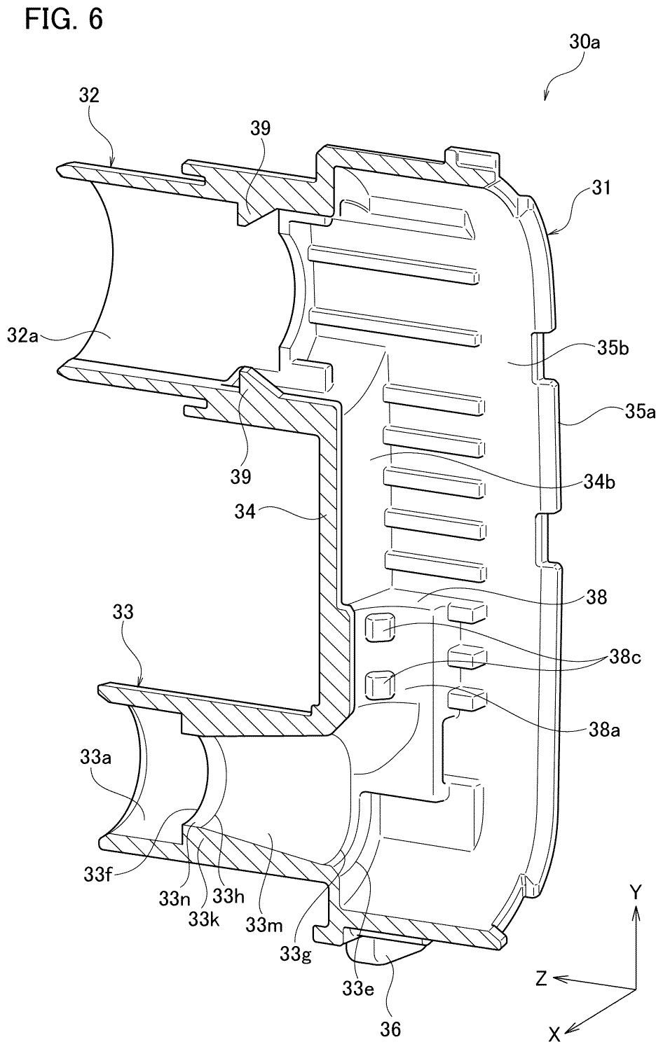

FIG. 5 is a perspective view of a connector 2 according to the second embodiment cut at the same position as that of FIG. 3 used in the description of the connector 1 according to the first embodiment. FIG. 6 is a perspective view of a cross section of the outer housing 30a according to the second embodiment extracted from FIG. 5. For the connector 2, parts having the same configuration or the same shape as those of the connector 1 according to the first embodiment are denoted by the same reference numerals, and a detailed description thereof will be omitted.

The connector 2 includes an outer housing 30a instead of the outer housing 30 included in the connector 1. The wire lead-out portion 33 of the outer housing 30a includes a plurality of routing holes 33k instead of the plurality of routing holes 33b included in the wire lead-out portion 33 of the outer housing 30.

Similarly to the plurality of routing holes 33b, the first opening end 33e and the second opening end 33f are defined in the plurality of routing holes 33k. However, in the routing holes 33k in this embodiment, a part of the inner peripheral surface 33n constitutes the inclined surface 33m that continuously formed along the inner periphery. Similarly to the inclined surface 33c in the first embodiment, the inclined surface 33m in this embodiment has the first end 33g at one end, and the second end 33h at the other end. The inclined surface 33m is inclined so that the distance L to the extension axis AX gradually narrows from the first opening end 33e toward the second opening end 33f.

In the direction from the first end 33g toward the interior of the housing body 31, no portion of the plurality of routing portions 33k is narrower than an opening part at the first end 33g. For example, in the second direction corresponding to the Y direction, an opening distance at the first end 33g is indicated by the first distance L1, as illustrated in FIG. 5. The second end 33h forms a narrowest opening part at the routing holes 33k. For example, in the second direction corresponding to the Y direction, an opening distance at the second end portion 33h is indicated by the second distance L2, as illustrated in FIG. 5. The second distance L2 is smaller than the first distance L1 for the first end 33g. Here, the second end 33h has a circular shape whose inner diameter is represented by the dimensional value of the second distance L2. In this case, an inner diameter of the second end 33h, that is, the dimensional value of the second distance L2, may be set equal to the outer diameter D of the electric wires 100.

Thus, in the connector 2, the inclined surface 33m may be at least a part of the inner peripheral surface 33n of the routing holes 33k.

With the connector 2, an effect equivalent to that of the connector 1 according to the first embodiment can be obtained. In particular, with the connector 2, for example, the shape of the routing holes 33k is made simpler than the shape of the routing holes 33b according to the first embodiment. As a result, it is advantageous that the shape of the outer housing 30a itself can be made simpler.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector connected to an external connector, comprising:
a plurality of terminals;
a housing body that receives ends of a plurality of electric wires joined to each of the terminals;
an electric wire lead-out portion in a cylindrical form that is continuous with the housing body and leads out the plurality of electric wires to the outside in a first direction of connection to the external connector; and
a wire packing that is attached to an inner wall surface of the electric wire lead-out portion in a closely contacted manner, and has a plurality of packing holes that allows the electric wires pass through while closely contacting with each of the electric wires;
wherein:
the electric wire lead-out portion has a plurality of routing holes that allow each of the electric wires to be routed between a first opening end that faces the inside of the housing body and a second opening end that faces a part of the wire packing attached to the inner wall surface in a first direction;
each of the routing holes includes an inclined surface in which a distance to an extension axis of a central axis of the packing holes becomes closer from a first opening end toward a second opening end;
a first end of the inclined surface at a position closest to the first opening end faces an interior of the housing body in a direction opposite to the first direction; and
a second end of the inclined surface at a position closest to the second opening end forms a narrowest opening part in the routing holes.

2. The connector according to claim 1, wherein:
each of the routing holes has an inner peripheral surface partially continuous with the inner wall surface to which the wire packing is attached;
a plurality of ribs arranged along an inner periphery of the inner peripheral surface so as to be spaced from each other; and
the inclined surface is provided for each of the ribs.

3. The connector according to claim 1, wherein the inclined surface is at least a part of the inner peripheral surface of the routing holes.
